(19) United States
(12) Patent Application Publication
(10) Pub. No.: US 2015/0025904 A1
(43) Pub. Date: Jan. 22, 2015

(54) SYSTEM AND METHOD FOR PATIENT AND HEALTHCARE-RELATED MESSAGING

(71) Applicants: D. Rao SHASKAR, Newark, DE (US); Edward SEUGLING, Mullica Hill, NJ (US); Roger KERZNER, Chadds Ford, PA (US); DGRK INNOVATIONS, LLC, Wilmington, DE (US)

(72) Inventors: D. Bhaskar Rao, Newark, DE (US); Edward Seugling, Mullica Hill, NJ (US); Roger Kerzner, Chadds Ford, PA (US); Jonathan Kamen, Wilmington, DE (US)

(21) Appl. No.: 14/383,389

(22) PCT Filed: Mar. 8, 2013
(86) PCT No.: PCT/US13/29867

§ 371 Date: Sep. 5, 2014

Related U.S. Application Data
(60) Provisional application No. 61/608,892, filed on Mar. 9, 2012.

(51) Int. Cl. H04L 12/58; G06Q 50/22; G06Q 10/10

(52) U.S. Cl. CPC H04L 51/04; H04L 51/16; G06Q 10/107; G06Q 50/22
USPC 705/2

(57) ABSTRACT

A system and method for patient-related messaging is disclosed herein. The system provides a micro-blogging plat-form accessible by computer systems (via a web portal using a conventional web browser) or mobile phones operated by medical personnel. The system allows medical personnel to post and/or view messages related to patient care, which could include a status identifier to communicate information quickly and effectively. The messages are easily filtered and organized according to a user's preferences, such as by using role-based filters.

### FIELD

The present disclosure relates to messaging systems for medical professionals. In particular, the present disclosure relates to a system and method for patient and healthcare-related messaging.

### BACKGROUND

In the medical community, continuous patient monitoring and comprehensive communication of patient information among medical professionals, such as doctors, nurses, etc., is of paramount importance. Currently, patient monitoring is often accomplished by periodic visits by doctors with patients, as well as phone calls and other types of communications between medical personnel regarding the status and treatment of patients. Communication of patient-related information between medical professionals can be limited by various factors, such as the lack of real time access to medical information regarding patients. Current existing medical record systems do not promote efficient, real-time documentation, and do not adequately allow real-time sharing of medical information between multiple medical providers, which results in medical errors and financial healthcare loss.

Email and text messaging are well-known in the art, but both are of limited functionality and customization in connection with healthcare-related communications. Such modes of communication often require a doctor or other medical professional to individually identify each recipient of each message. Additionally, there often is not a way to easily and quickly organize messages by patient, or by other medical criteria. Further, there is currently no system for a healthcare provider to communicate in real time with multiple healthcare providers about a patient, for effective coordination of clinical care.

Accordingly, what would be desirable, but has not yet been provided, is a system and method for patient and healthcare-related messaging, which addresses the foregoing limitations of existing messaging systems.

### SUMMARY

The present disclosure relates to a system and method for patient-related messaging. The system provides a micro-blogging platform accessible by computer systems and mobile communications devices (e.g., cellular phones, smart phones, etc.) operated by medical personnel, and allows medical personnel to exchange messages related to patient care.

The system allows a user to subscribe and unsubscribe to desired message threads, where the message threads may be generic in nature (e.g., messages relating to general healthcare topics), patient-centric (e.g., messages relating to care of a specific patient), and/or team-centric (e.g., a team of doctors that collectively provide care to one or more common patients). Users can create new message threads, or new messages within existing message threads. Each message can include a status identifier to communicate information quickly and effectively, such as whether a message is urgent. The messages are easily filtered and organized according to a user's preferences, such as by using role-based filters.

The system also includes a profile page where users may edit account information and manage filters. Optionally, the system communicates with a patient data system to retrieve patient information. The system could be accessed via a web portal using a conventional web browser, and/or a mobile application (e.g., installed on a smart phone, etc.) having the same functionality as, but a different user interface than, the web portal.

### BRIEF DESCRIPTION OF THE DRAWINGS

The foregoing features of the disclosure will be apparent from the following Detailed Description, taken in connection with the accompanying drawings, in which:

FIG. 1 is a diagram showing the system of the present disclosure.

FIG. 2 is a diagram illustrating interactive display screens for creating and exchanging patient-centric and team-centric message threads.

FIG. 3 is a screenshot illustrating a web portal generated by the present disclosure.

FIGS. 4A-4B are screenshots illustrating a new thread creation wizard generated by the present disclosure.

FIG. 5 is a screenshot illustrating a profile page and a Manage Filters pane.

FIG. 6 is a screenshot illustrating an administration page generated by the present disclosure.

FIG. 7 is a screenshot illustrating a thread list display screen generated by the mobile client version of the present disclosure.

FIGS. 8A, 8B, and 9 are screenshots illustrating conversation display screens generated by the mobile client version of the present disclosure.

FIG. 10 is a flowchart showing processing steps according to the present disclosure for allowing users to select and edit message threads.

FIG. 11 is a flowchart showing processing steps according to the present disclosure for allowing users to create new message threads.

FIGS. 12A, 12B, 13, 14, 15A, 15B, 15C, 15D, 15E, 15F, and 15G are screenshots illustrating alternate patient-centric and team-centric user interface screens that can be generated by the mobile client version of the present disclosure.

### DETAILED DESCRIPTION

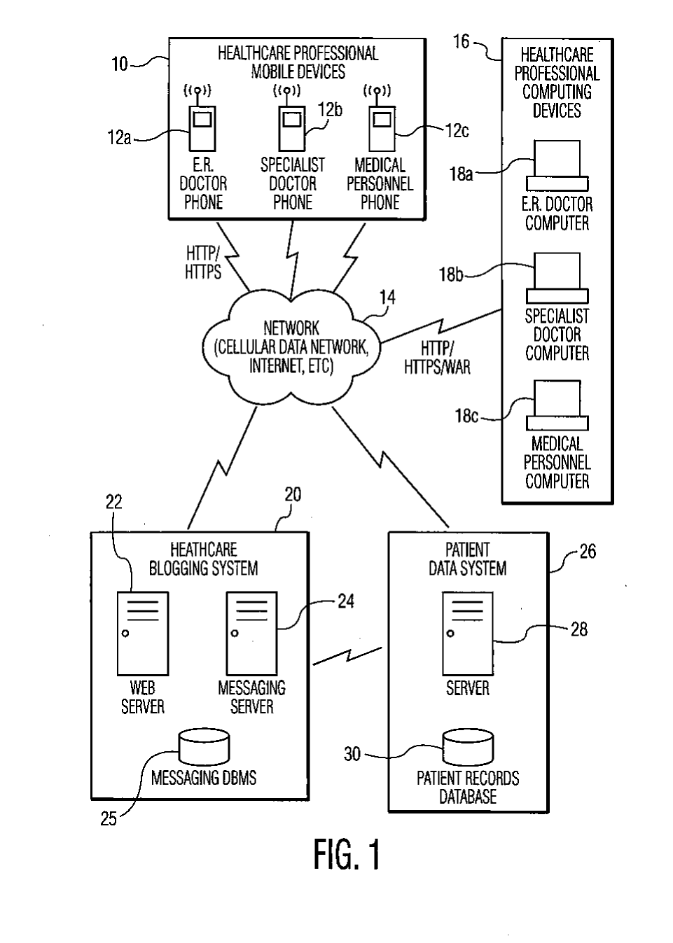

The present disclosure relates to a system for patient-related messaging, as discussed in detail below in connection with FIGS. 1-15G.

As shown in FIG. 1, the messaging system of the present disclosure is indicated generally at 20. A plurality of mobile devices 10 and/or computing systems 16 operated by various healthcare professionals can be utilized to access the present disclosure, such as an emergency room doctor's phone 12a or computer 18a, a specialist's phone 12b or computer 18b, and other medical personnel's phone 12c or computer system 18c (e.g., a computer system installed at a nursing workstation, etc.). These systems could communicate with the messaging system 20 of the present disclosure via the network 14, e.g., via the Internet, through a Local Area Network (LAN), Wide Area Network (WAN), etc., using hypertext transfer protocol (HTTP), secure HTTP (HTTPs), Web Application Archive files (WAR), etc. In such circumstances, the messaging environment hosted by the system 20 could be accessed using conventional web browsers and/or locally-installed applications executing on the systems 18a-18c. It is noted that any desired numbers and types of computing systems could be utilized.

The messaging system 20 includes a web server 22 which generates a web portal accessible by the phones 12a-12c and the computer systems 18a-18c, through which portal medical personnel can post and/or view messages in real time relating to the treatment of patients and other subjects. The system 20 enables one medical professional to effectively communicate with multiple medical professionals, instead of having to reach individual members via phone, email, or text message.

The web server 22 handles authentication/logging in of remote users, generates code and/or scripts executed by the phones 12a-12c and the computer systems 18a-18c for displaying, accessing, and using the web portal, and processes incoming messages generated by the remote users. A messaging server 24 is also provided, and includes a database 25 for storing messages generated by remote users and transmitted to the system 20 via the web server 22. The messaging server 24 also organizes messages (e.g., according to message threads, subject matter, etc.) and generates alerts when new messages are received. The alerts are dispatched to the phones 12a-12c and the computer systems 18a-18c to alert users to new messages that have been posted. The database 25 could be supported by any suitable, commercially-available relational database management system (RDBMS), such as Oracle RDBMS, Microsoft SQL Server, MySQL, etc. It is noted that the functionalities provided by the servers 22 and 24 could be combined into a single server, if desired.

The messaging system 20 can communicate with a patient data system 26 to obtain information relating to patients at a healthcare facility currently receiving treatment. Such information could be used by the messaging system 20 to associate messages posted by remote users with specific patients, and to organize messages into patient threads, if desired. The patient data system 26 could be at a hospital or other medical facility, and could include a server 28 and an associated patient records database 30 which stores patient information. The patient data system 26 could communicate with the system 20 via a LAN or WAN connection, for example, if the system 26 and the system 20 are at the same location or within the same enterprise network, and/or it could communicate with the system 20 via the Internet. The patient data system 26 could be located at a medical facility, e.g., a hospital, or remote therefrom.

It is noted that, if local software applications are installed in the phones 12a-12c and the computer systems 18a-18c, the functionality provided by the web server 22 need not be provided, and the phones 12a-12c and/or the computer systems 18a-18c could communicate directly with the messaging server 24 without requiring the use of a web portal. In such circumstances, the local applications could generate local user interface display screens which present the blogging environment to the users and allow the users to post and/or view messages. The local application could be provided to users by way of a downloadable “app” that can be installed locally and obtained from a central repository, e.g., from the Apple “App” Store, Google's Android repository, etc. Of course, the local application need not be utilized, and access could be by way of a conventional web browser (in which case the web server 22 is needed to provide the various web pages/scripts necessary for generating/accessing the blogging environment).

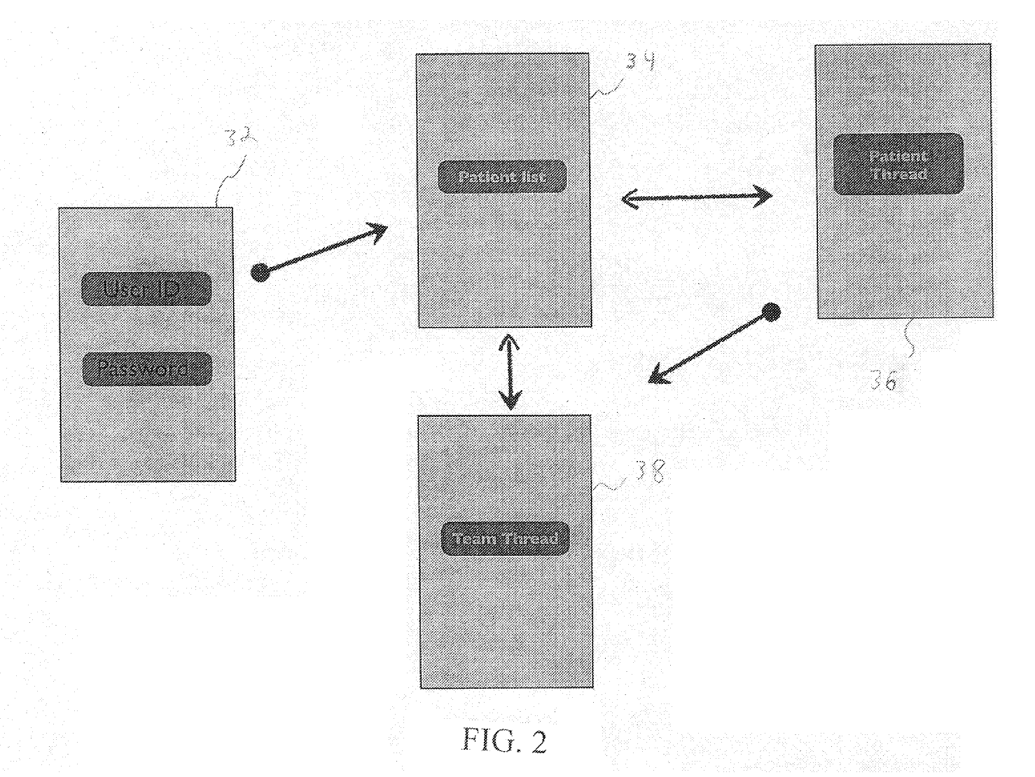

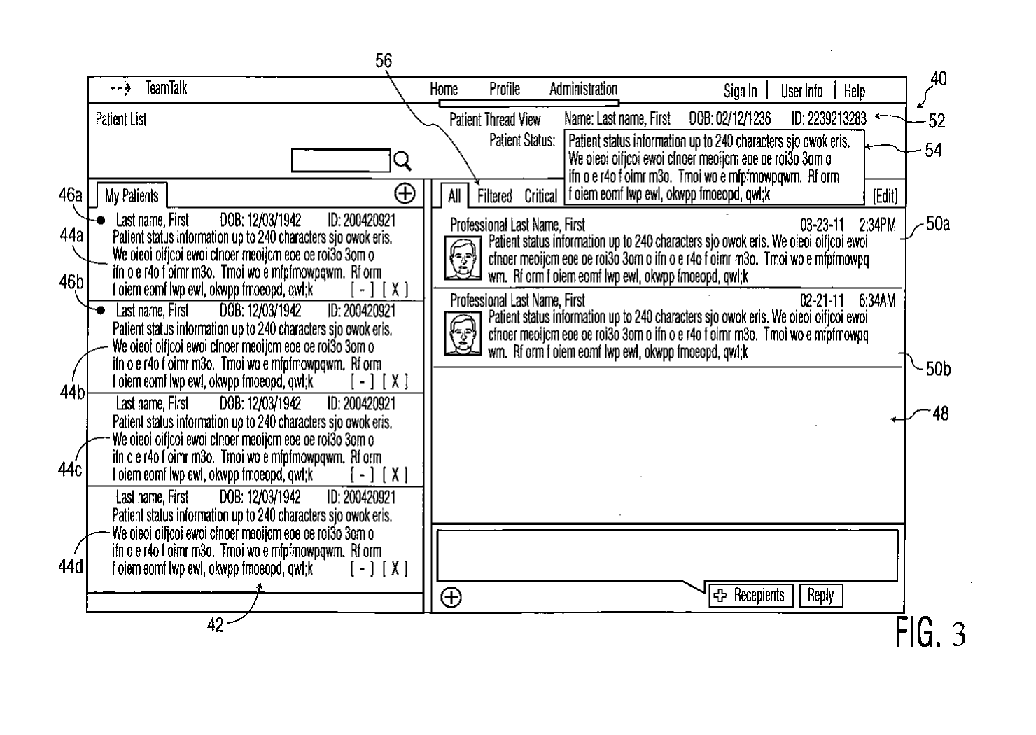

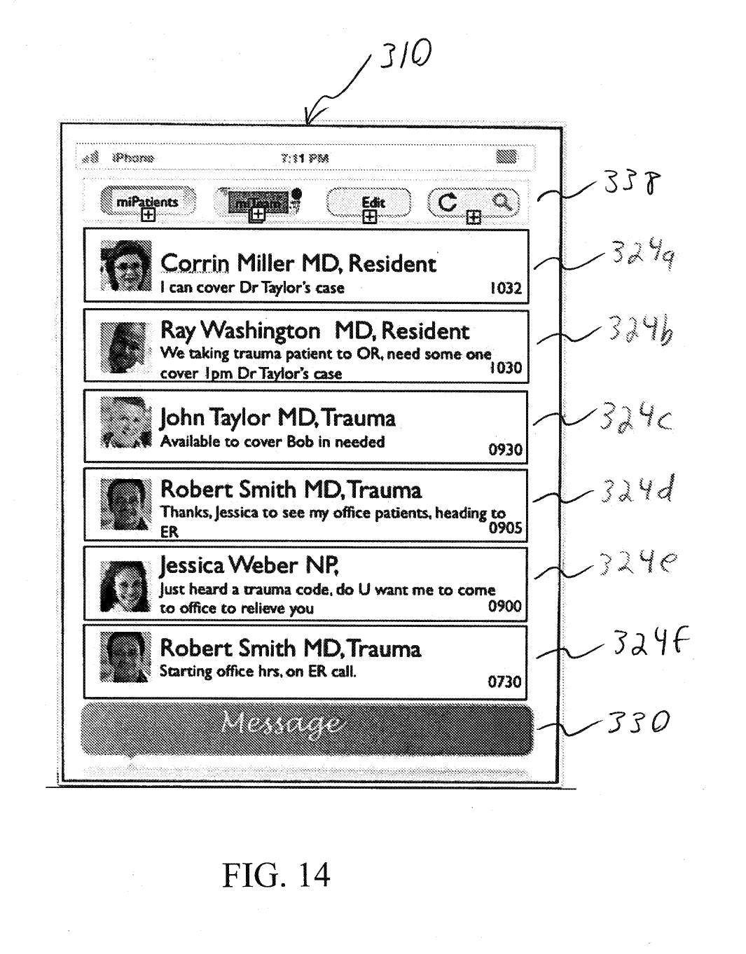

FIG. 2 is a diagram illustrating interactive display screens that can be generated by the system, relating to patient-centric and/or team-centric message threads. When a user first accesses the healthcare blogging system 20, the user is presented with a sign-in screen 32. After the user enters a user ID and password at the sign-in screen 32, the system proceeds to one of a plurality of display screens. The default display screen after sign-in is preferably a patient-centric display screen 34, discussed in greater detail below with FIGS. 3, 7, and 12A-12B. The user could then navigate to individual patient threads 36, discussed in further detail below with FIGS. 3, 8A-9, and 13, or a team-centric display screen 38, discussed in further detail below with FIG. 14.

FIG. 3 is a diagram showing the web portal 40 of the present disclosure, which allows medical personnel to post and/or view messages, indicated at 50a-50b, relating to patient healthcare and other topics. The portal 40 could be accessed and displayed using a web browser executed by the phones 12a-12c, and/or the computer systems 18a-18c. The portal 40 includes a message (blog) thread screen area 42 which displays a plurality of message threads 44a-44d. The message threads 44a-44d relate to messages 50a-50b, which could be generic, patient-centric (i.e., patient-related), or team-centric. Each message thread 44a-44d may display a summary text about the message thread 44a-44d, specifically, about the patient if the message thread 44a-44d is patient-centric, or about the thread topic if the message thread 44a-44d is generic. The summary text could alternatively display the most recent message 50a-50b.

Patient-centric message threads pertain to specific patients being treated by a user of the system. Thus, for example, message thread 44a could relate to messages pertaining to a first patient being treated by various medical personnel, message thread 44b could relate to messages pertaining to a second patient being treated by the medical personnel, etc. Patient-centric messaging enables a healthcare professional to quickly extract meaning from a message 50a-50b, and respond immediately to a patient's needs. Further, patient-centric messaging facilitates a healthcare provider to effectively communicate, coordinate, and enhance patient care and health outcomes.

Team-centric message threads pertain to a specific team of professionals, usually a specialty or a committee within a hospital (e.g., vascular surgeon team, cardiology, trauma), as well as their patients. All the members of a team, such as an emergency response medical team (e.g., trauma team, stroke team, cardiac arrest team, etc.), can be sent a message, or otherwise notified, at the same time.

A user can, among other things, subscribe to a particular message thread 44a-44d, unsubscribe from a particular thread, create a new thread, close a thread, or search threads. Closing a message thread 44a-44d can unsubscribe everyone from that thread, but users will still be able to view and print the history of a closed thread.

Status identifiers 46a-46b are also provided, and indicate to the user whether a message thread includes unviewed (new) messages by displaying the color blue, and indicate to the user whether a message thread includes an urgent message by displaying the color red or displaying an inner concentric circle. Conveniently, this allows the user to quickly ascertain message threads which should receive urgent attention. For example, if a primary doctor's patient has just been admitted to the emergency room of a hospital, the treating emergency room physician can create an urgent message using the present disclosure and post it to the system along with an indication that the message is urgent. When the primary doctor accesses the system of the present disclosure, a red indicator appears next to the message thread 44a-44d associated with the patient, alerting the primary doctor to the fact that an urgent (i.e., stat) message exists in connection with the patient.

Optionally, message threads 44a-44d could require an acknowledgement by the user, such as by clicking on the message thread 44a-44d. The required acknowledgement could be conveyed to the user by the status identifier 46a-46b (e.g., using another color), or through some other mechanism.

A “conversational” screen area 48 is also provided in the portal 40. The area 48 indicates the message thread selected (such as by displaying patient information 52 and patient status 54) and specific messages 50a-50b relating to one of the threads 44a-44d, and is automatically updated when the user clicks on one of the threads 44a-44d. Each displayed message 50a-50b can show a variety of information, such as the content of the message, the author of the message, and the time and date it was posted. Additionally, the sender can prioritize a message 50a-50b depending on the clinical necessity (e.g., stat, urgent, routine, etc.).

The message threads 44a-44d could also be patient-centric, and could include a patient list displaying a plurality of patients and information about the patient and the status of the patient. Clicking on a patient from the patient list updates the patient information 52, patient status 54, and related messages 50a-50b in the conversational screen area 48. Information about the patient 52 could include such information as the patient's name, date of birth, hospital ID, diagnosis, location, etc. Information regarding the status of the patient 54 could indicate the condition of the patient or current symptoms, e.g., stable, nauseous, etc. The patient information 52 and status information 54 of a plurality of patients could be imported from, or integrated with, hospital data from admissions and discharges software.

The present disclosure could include a default view so that the message threads 44a-44d are organized in descending order, such that message threads 44a-44d with the most recent activity are listed first. The corresponding messages 50a-50b contained therein would similarly be organized in descending order, such that the most recently added messages are listed first.

As shown, the message threads 44a-44d and messages 50a-50b could be grouped and organized by tabs, indicated at 56. For example, a user of the system (e.g., a doctor) could click on a “My Patients” tab 56 in the message thread screen area 42 to quickly and conveniently access message threads 44a-44d containing messages 50a-50b related to that user's patients. The message threads 44a-44d could also include a “Subscribed” tab to view all of the message threads 44a-44d, generic and patient-centric, that a user is currently subscribed to, as well as a “Closed” tab to view all of the message threads 44a-44d that the user was once subscribed to. It is contemplated that additional tabs could be used to distinguish between active and closed threads. Additionally, a tab could be created when the user performs a search for message threads 44a-44d on a particular subject. The messages in the conversation screen area could be organized in a fashion similar to that of the threads in the thread screen area, such as by displaying the most recent messages or only critical messages by clicking on a corresponding tab 56.

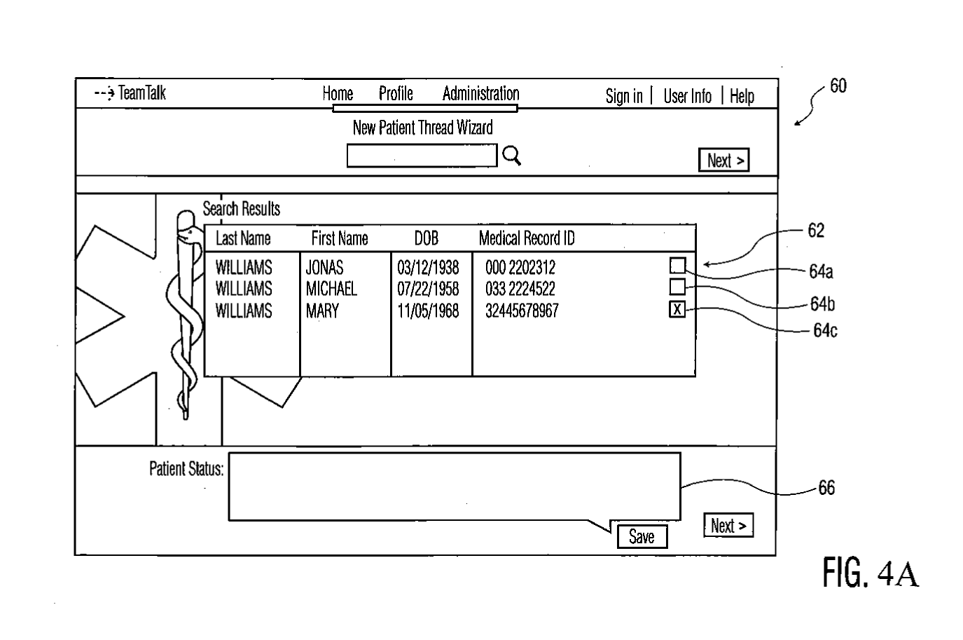

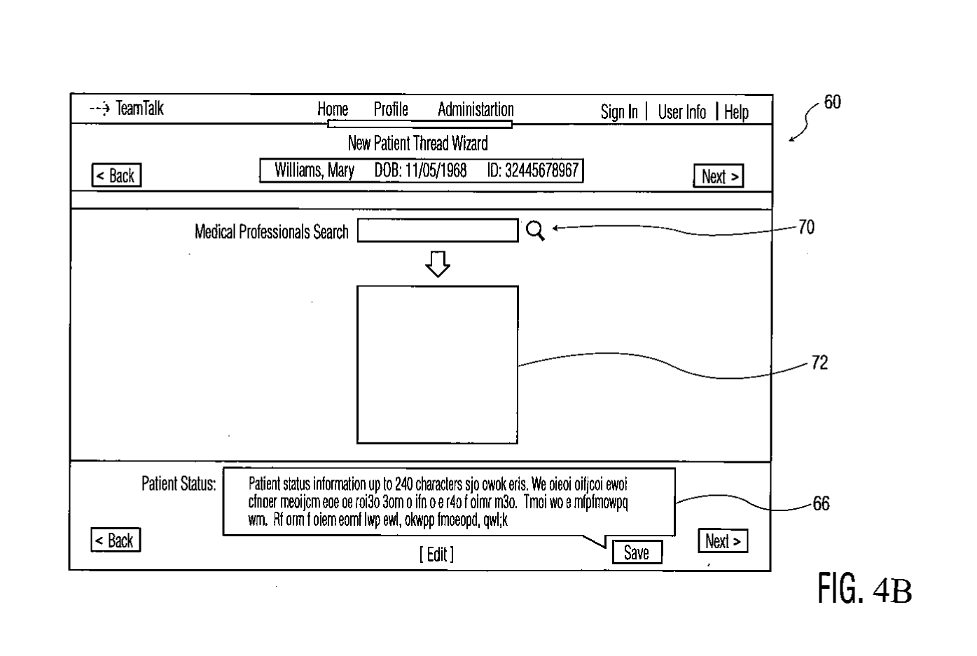

As shown in FIGS. 4A-4B, the web portal 40 includes a new thread creation wizard 60. The new thread creation wizard 60 guides the user through the process of creating a new message thread. The wizard allows the user to decide whether the new message thread will be generic, patient-centric, or team-centric. For patient-centric threads, the user can conduct a search for a patient using a search tool. Preferably, the system searches and retrieves information from a hospital's system records (e.g., using the patient data system 26 of FIG. 1).

As shown in FIGS. 4A-4B, the search tool returns a list 62 of patient search results that provide basic user then selects the specific patient, or patients, on which to base the thread, such as by check boxes 64a-64c. information about the patient, such as first name, last name, date of birth, and medical record ID. The user can create a patient-related or generic thread summary 66. When a user creates a new thread 44a-44d the system could be set up to pre-populate the current thread summary 66 with a prior thread summary, if available, of a previous message thread by the same user. Referring to FIG. 4B, after choosing a specific patient, or choosing a generic topic or team type, a medical professionals search tool 70 can be used to find medical professionals, or a group of medical professionals, to add to the new message thread. In a preferred embodiment, the search tool 70 is of the “type-ahead” type, meaning that the search tool 70 searches for results while the user is typing the search in real time. The user could then choose whether to add the professional or group to the message thread, thereby adding such individuals to a displayed list 72.

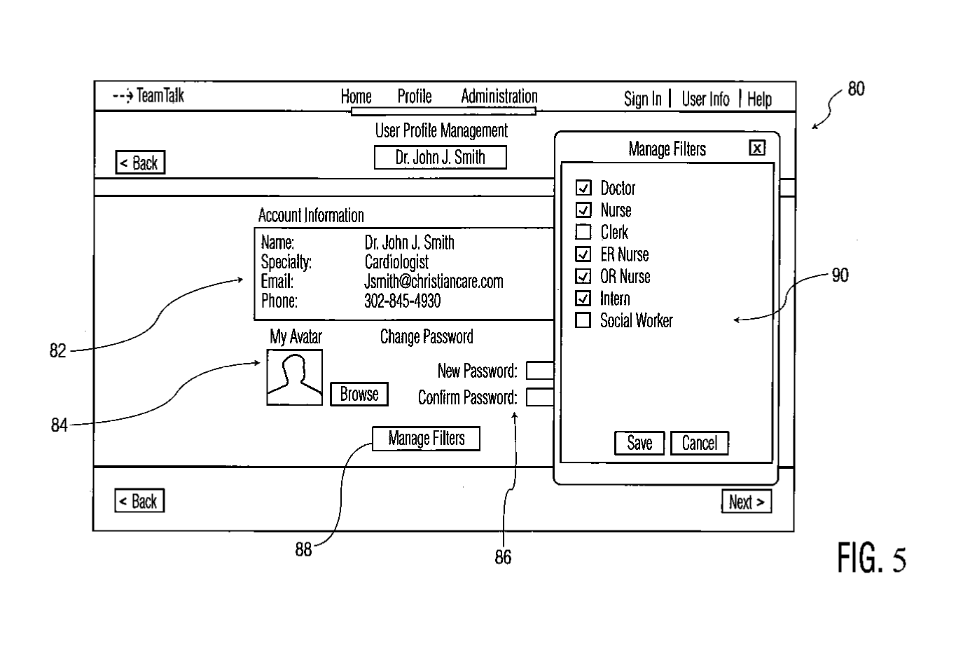

Referring to FIG. 5, the system includes a profile page 80 where the user may review and update account information, generally indicated at 82, as well as user settings. The account information 82 could include the user's name, specialty, and contact information. A user's profile picture could also be displayed and edited using the profile page 80. The user could use the change password tool 86 to change the password used to access the system at login. Additionally, users can also use the “Manage Filters” button to access the Manage Filters tool 90 to set up and change filters, such as role-based filters. Role-based filters could be used to easily sort messages 50a-50b by the roles of the authors of those messages. For instance, the role-based filter could be used to only view messages authored by doctors.

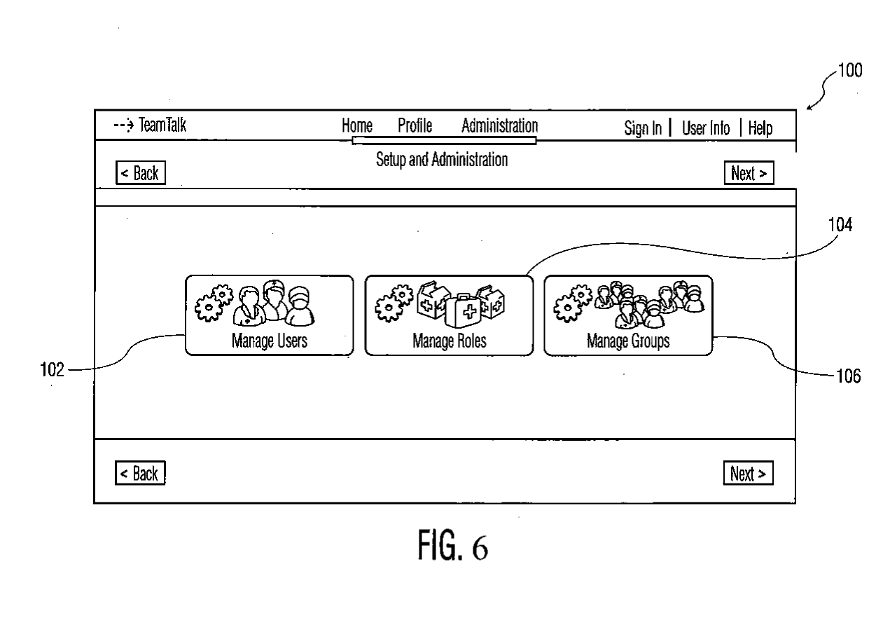

Shown in FIG. 6 is an administration page 100 where administrative users can perform functions not accessible to other users. For instance, from the administration page 100, administrators can manage users 102 by clicking on an icon and can create new users, as well as specify usernames, full names, titles (e.g., doctor, nurse, intern, etc.), email addresses, avatars, and phone numbers. Administrators can also have the ability to reset passwords, edit user information, and designate other users as administrators. By clicking the “Manage Roles” button 104 from the administration page 100, administrators may be able to create new roles and set up permissions for each role. Administrators can also click a button 106 to access screens for managing of users, such as by creating, modifying, and deleting groups. Optionally, administrators can modify or delete specific messages and/or threads.

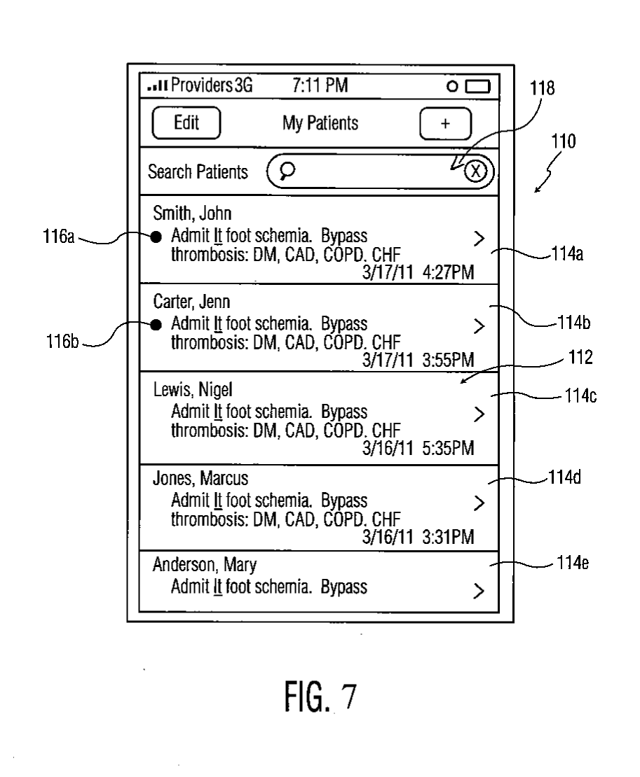

As mentioned above, the present disclosure could be provided in the form of software “apps” or clients on mobile phones, as shown in FIGS. 7-9. The aesthetic appearance of the mobile client, and potentially some functionality, can differ depending on the mobile phone used and due to differences in proprietary software between phone manufacturers. Shown generally at 110 in FIG. 7 is a thread display screen. The thread display screen 110 provides the same functionality as the message thread screen area 42 of the web portal 40. The thread display screen 110 includes a thread message screen area 112 which displays a plurality of message threads 114a-114e. As in the web portal 40, the message threads 114a-114e could relate to messages pertaining to specific patients being treated by a user of the system (patient-centric), they could relate to activities or messages from team members (team-centric), or they could be generic in nature. Each message thread 114a-114e could display a summary text about the thread. Status identifiers 116a-116b are also provided, and, as in the web portal 40, these communicate information about the message thread to the user, e.g., by displaying a particular color or shape to indicate message importance (e.g., routine message or urgent message), etc. The thread display screen 110 could also comprise a toolbar 118, which could comprise a search bar.

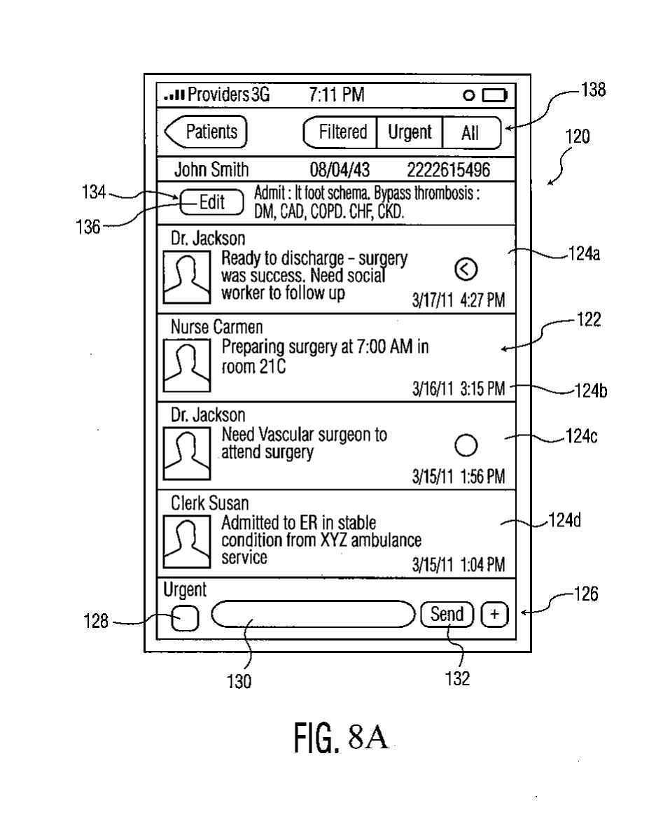

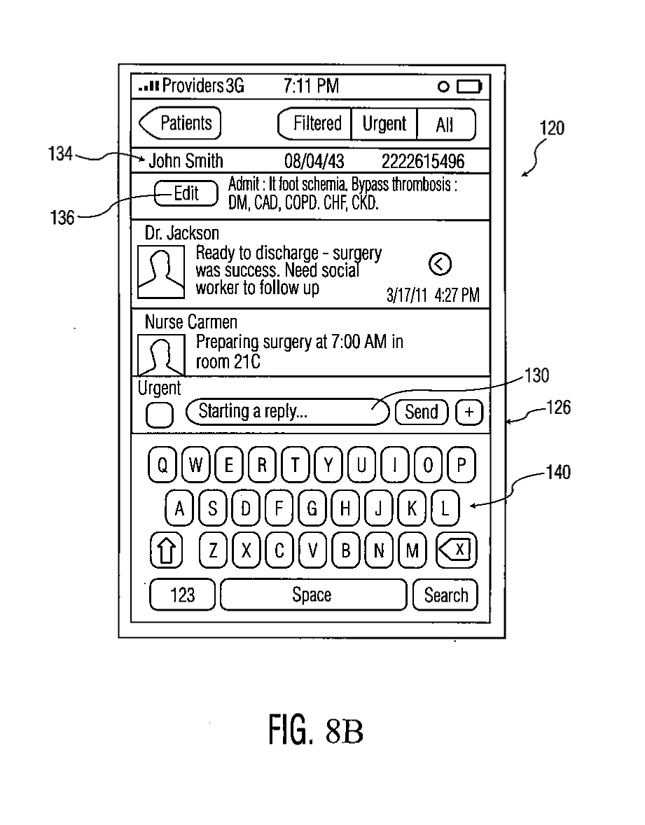

Another aspect of the mobile application is shown in FIGS. 8A-9. Referring to FIG. 8A, a conversation display screen 120 is provided in the mobile application, and functions similar to the conversation screen area 48 of the web portal 40. The conversation display screen 120 includes a conversational screen area 122 which displays specific messages 124a-124d. Each displayed message 124a-124d could include a variety of information such as the content of the message, the author of the message, and the time and date it was posted. As in the web portal 40, the conversation display screen 120 could also include tabs 138, shown in FIG. 8A, for allowing a user to filter messages (such as by displaying only urgent messages by clicking on the “Urgent” tab). From the conversation display screen 120, the user can access the message toolbar 126, which allows the user to mark a message as urgent, and/or to type a reply, by clicking a corresponding icon as indicated at 128. The “Send” button 132 can be clicked to send the reply.

A new message can be created by clicking on the message area 130. As shown in FIG. 8B, by clicking on the message area 130, virtual keyboard 140 is displayed for the user to type his/her message. This function is especially important for mobile phones that do not have a physical keyboard, such as an iPhone. Referring to FIG. 8A, after the message is composed, the user can post or send the message by clicking the “Send” button. A patient information area 134 could also be included for displaying patient-related information, such as name, date of birth, and medical ID. The patient information area 134 can also display a status summary, which a user can edit by clicking on a corresponding “Edit” button 136. As shown in FIG. 9, the user can update the status summary typically by using the virtual keyboard 140 and then clicking on the “Done” button 142 after the status has been updated.

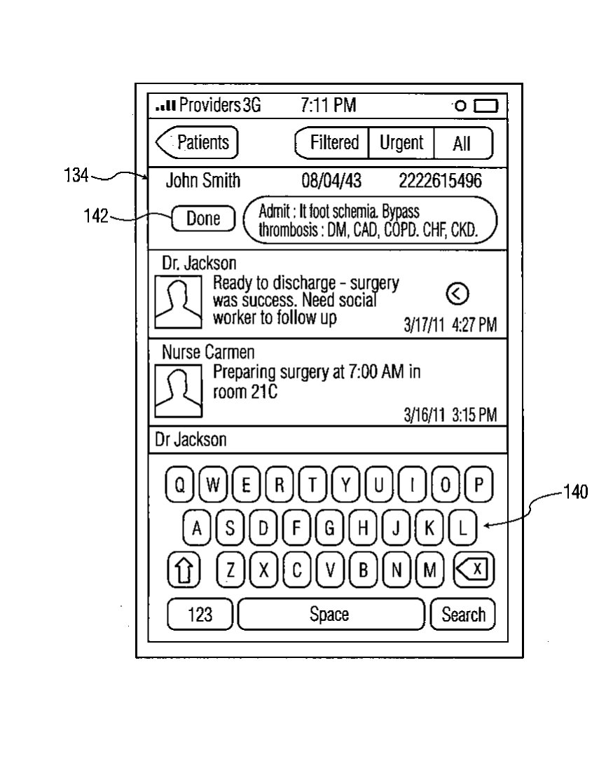

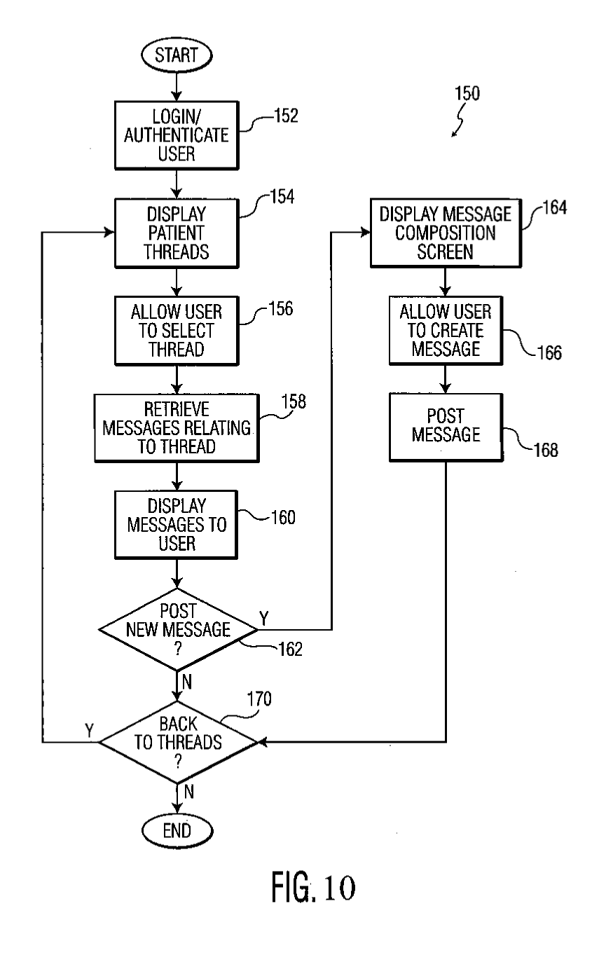

FIG. 10 is a flowchart showing overall processing steps, indicated generally at 180, carried out by the present disclosure. In step 152, the user logs into and/or is authenticated by the system of the present disclosure. The system could include a selectable option to have the system automatically sign in the user for subsequent sessions (e.g., by a “Remember Me” radio button). Once the user is logged in/authenticated, the system then displays the message threads in step 154. As discussed above, the threads could be patient-centric, team-centric, or generic. Then in step 156, the user selects a message thread. This sends a query to a database (e.g., database 25 of FIG. 1) in step 158 to retrieve the messages associated with the selected message thread. In step 160, the messages from this query are then displayed to the user. In step 162, a determination is made as to whether the user desires to post a new message to the selected message thread. If the user decides to post a new message, the system displays a message composition screen in step 164, otherwise, step 170 occurs. In step 166, the system allows the user to create a new message. Once the message is drafted, the system then posts the message in step 168, thus adding it to the message thread. Control then proceeds to step 170, wherein the user can choose whether to go back to the message threads or end the session. If the user decides to go back to the message threads control returns to step 154.

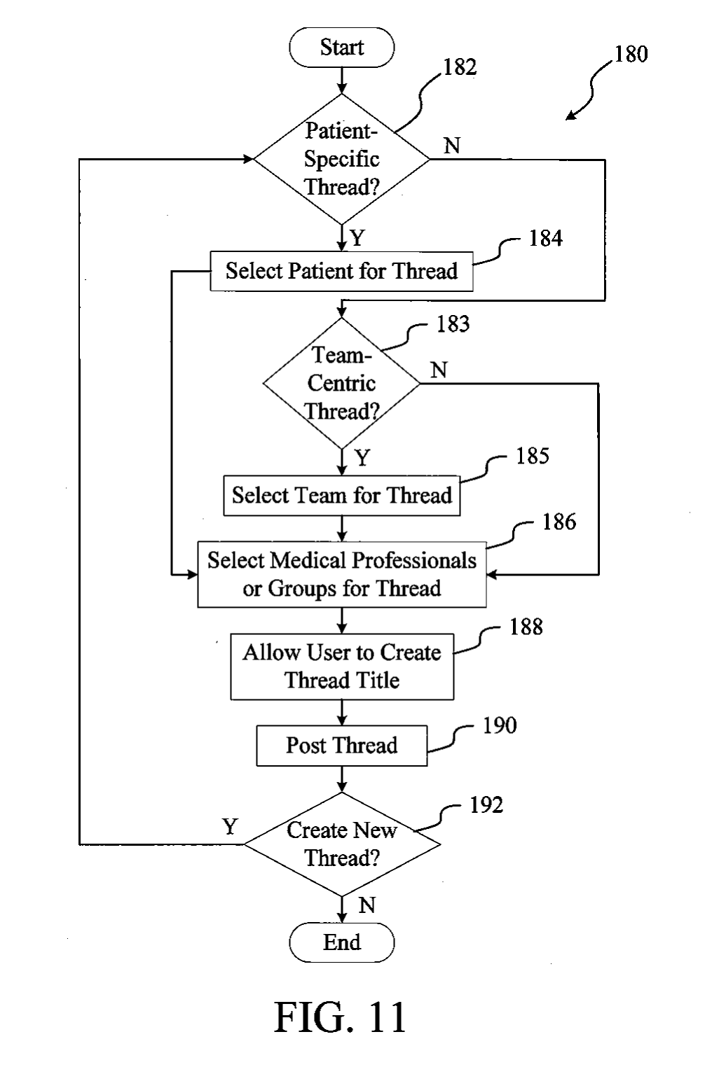

FIG. 11 is a flowchart showing processing steps, generally indicated at 180, for creating a new thread. As shown, in step 182, a determination is made as to whether the new thread is patient-related. If so, step 184 occurs, wherein the user selects a patient for the message thread and then proceeds to step 186. If not, control passes to step 183, where a determination is made as to whether the new thread is team-centric. If so, step 185 occurs, wherein the user selects a team for the message thread. If not, control passes to step 186. In step 186, the user selects one or more medical professionals or groups to be associated with the thread. Then in step 188, the user creates a title for the message thread. In step 190, the thread is posted by the system, so that it can be viewed by other users. Finally, in step 192, a determination is made as to whether the user wishes to create a new thread. If so, control returns to step 182.

It is noted that the system of the present disclosure could include a machine learning algorithm or a rules-based algorithm. A machine learning algorithm could automatically perform certain functions based on the use of the system by a user. For example, a machine learning algorithm could learn, over time, certain keywords that are often used when a user drafts messages. The algorithm could use these keywords to automatically address the message to one or more recipients (e.g., whenever the word radiology is typed in a message, the system could automatically address the message to one or more radiologists with whom a doctor often works).

A rules-based algorithm could also be pre-installed, have pre-installed prompts, or be set up by the user. These types of algorithms could be used, alone or in combination, so that the system automatically performs certain functions. For instance, the system could be programmed to automatically identify and populate a list of suggested recipients based on factors including the patient's name, the area of medicine discussed, the disease discussed, etc. Further, these algorithms could allow the user to associate a particular word with a particular recipient, or to set up a group-based rule such that the user could set up a mailing list to easily send a particular message to a group of recipients. The system may also be set up to prioritize and rank the importance of a message, such as by the date, urgency, relevance, or key words used in the text of a message.

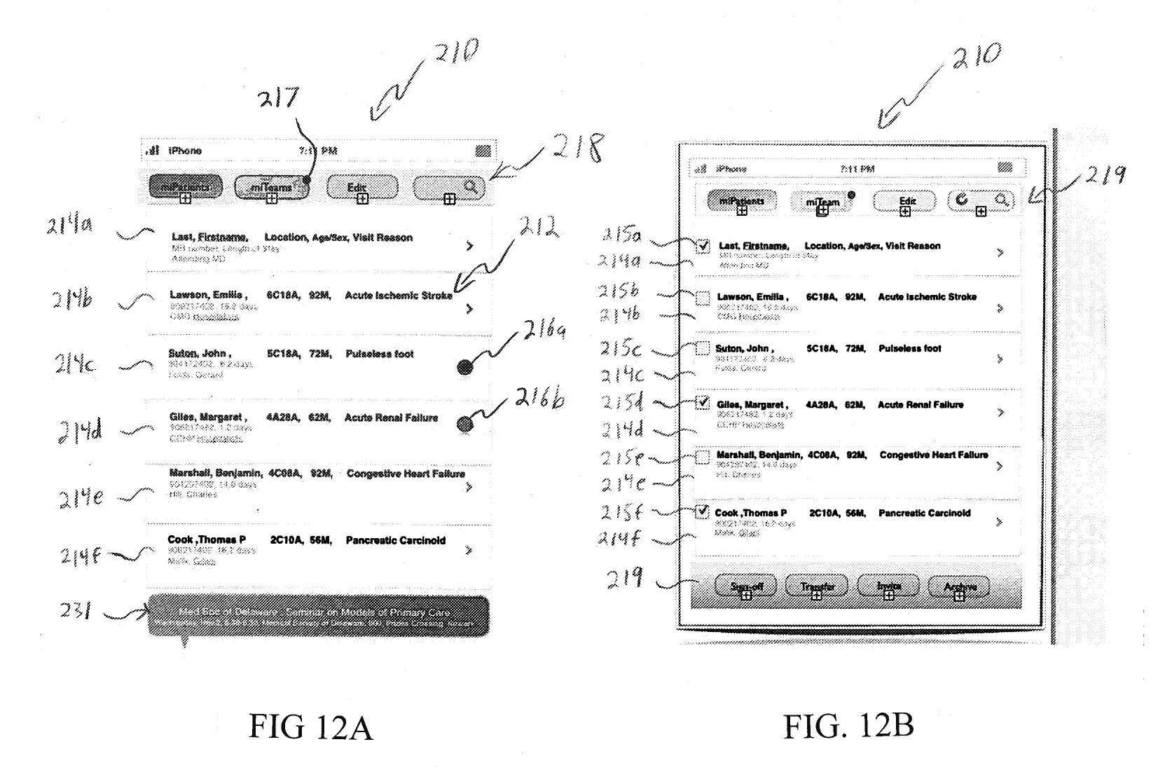

FIGS. 12A-15G are screenshots illustrating alternate patient-centric and team-centric user interface screens that can be generated by the mobile client. Each of these display screens will now be described in detail.

FIG. 12A is a screenshot illustrating a patient-centric display screen 210 of the mobile client. The patient-centric display screen 210 includes a thread message screen area 212 displaying a plurality of scrollable message threads 214a-214f (i.e., patient list). The message threads 214a-214f comprise status identifiers 216a-216b to alert the user of any urgent or unread messages. The message threads 214a-214f could further comprise patient information (i.e., patient summary), such as the patient's name, room, age, sex, reason for visit, medical record (MR) number, length of stay, and attending medical doctor (MD). The patient-centric display screen 210 could comprise a toolbar 218, as well as an advertisement/content display bar 231. The toolbar 218 could include buttons to allow a user to navigate between different display screens (e.g., patient-centric display screen and team-centric display screen), edit information, search (e.g., for a patient or a physician), and/or refresh. The buttons could be highlighted to signify which display screen a user is in, and could also comprise a status identifier 217 to alert the user of any unread or urgent message in a particular display screen (e.g., the patient-centric display screen or the team-centric display screen).

FIG. 12B is a screenshot illustrating the editing options of the patient-centric display screen 210 of the mobile client. Once a user selects the edit option in the toolbar 218, an editing toolbar 219 is displayed allowing a user to sign-off from a message thread 214a-214f (i.e., remove the patient), transfer a message thread 214a-214f to another doctor or medical professional, invite a doctor or medical professional onto the message thread 214a-214f, or archive the message thread 214a-214f. These alterations can be made concurrently to multiple message threads 214a-214f, such as by use of check boxes 215a-215f.

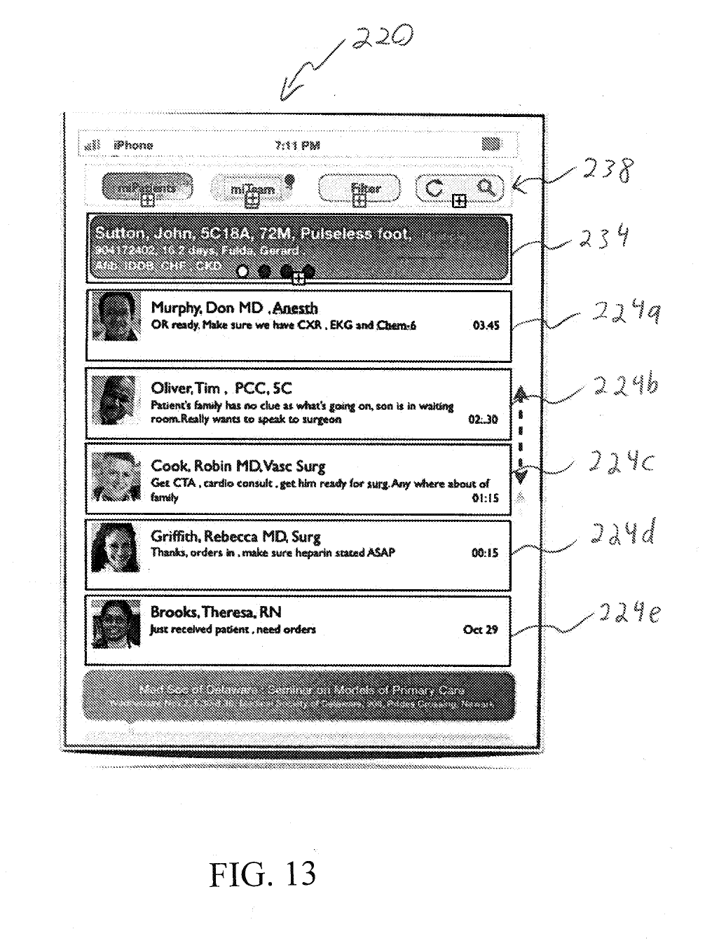

FIG. 13 is a screenshot illustrating a patient thread display screen 220 (e.g., conversation display screen) of the mobile client. The patient thread display screen 220 is accessible from the patient-centric display screen 210 of FIG. 12A by clicking on a message thread 214a-214f. The patient thread display screen 220 comprises scrollable messages 224a-224e, a patient information area 234 (i.e., patient information header or patient summary), and a toolbar 238 comprising a filter button to sort and filter messages 224a-224e. The patient information area 234 displays header information that is scrollable and easily editable.

FIG. 14 is a screenshot illustrating the team-centric display screen 310 of the mobile client comprising messages 324a-324f, a toolbar 338, and a message bar 330. The messages 324a-324f could comprise information about the author of the message (e.g., name, position, department, etc.). Team-centric messaging could be used to make announcements (e.g., for conference announcements), coordinate among team members or hospital employees (e.g., to coordinate resources and plan activities), and push content (e.g., to post a journal article).

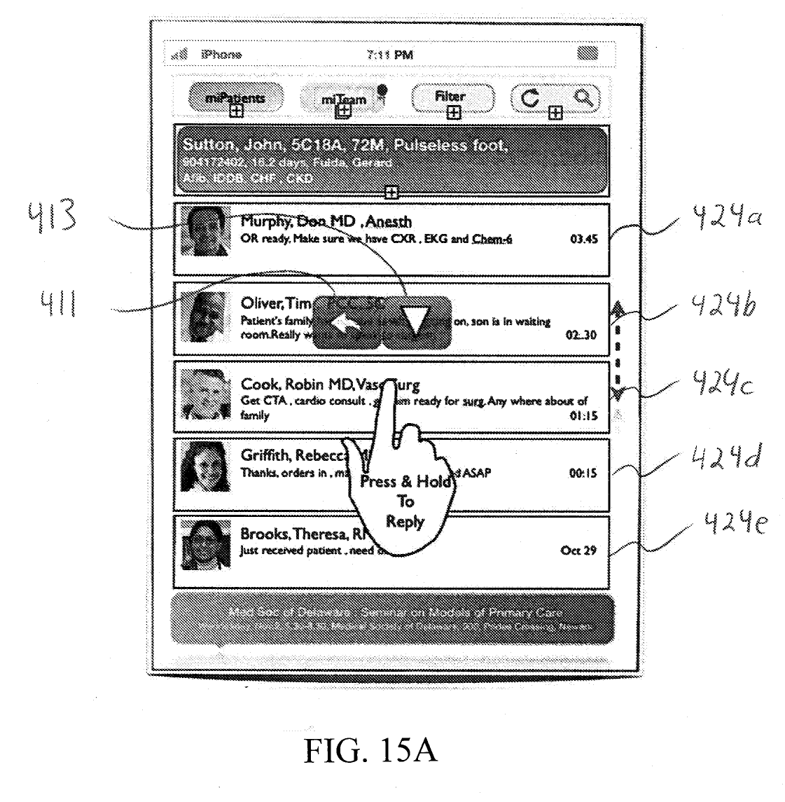

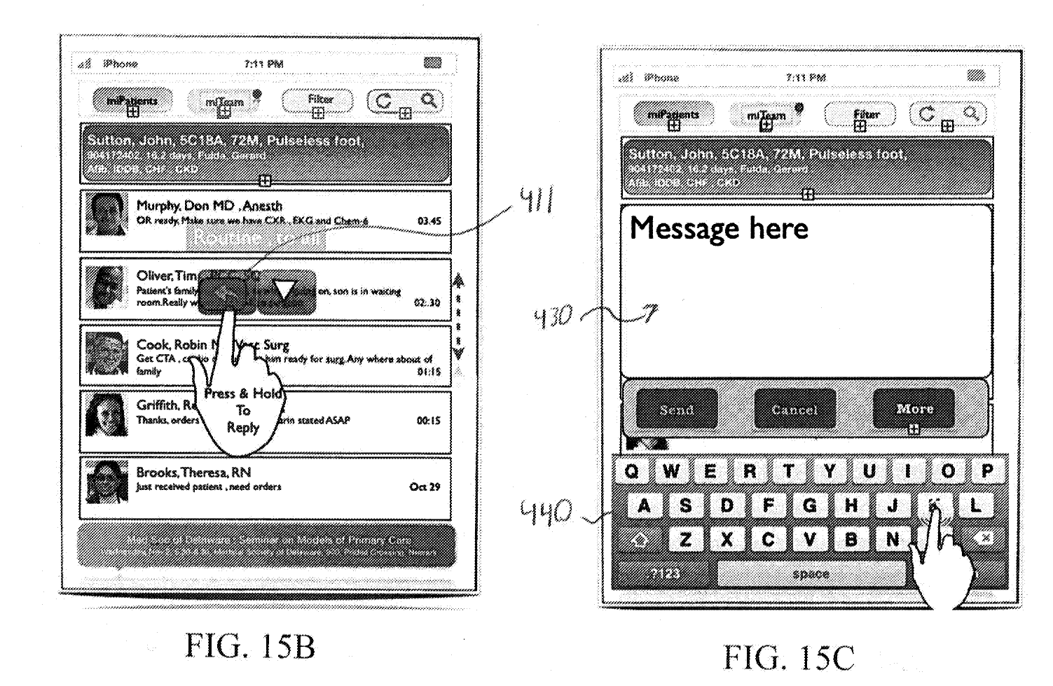

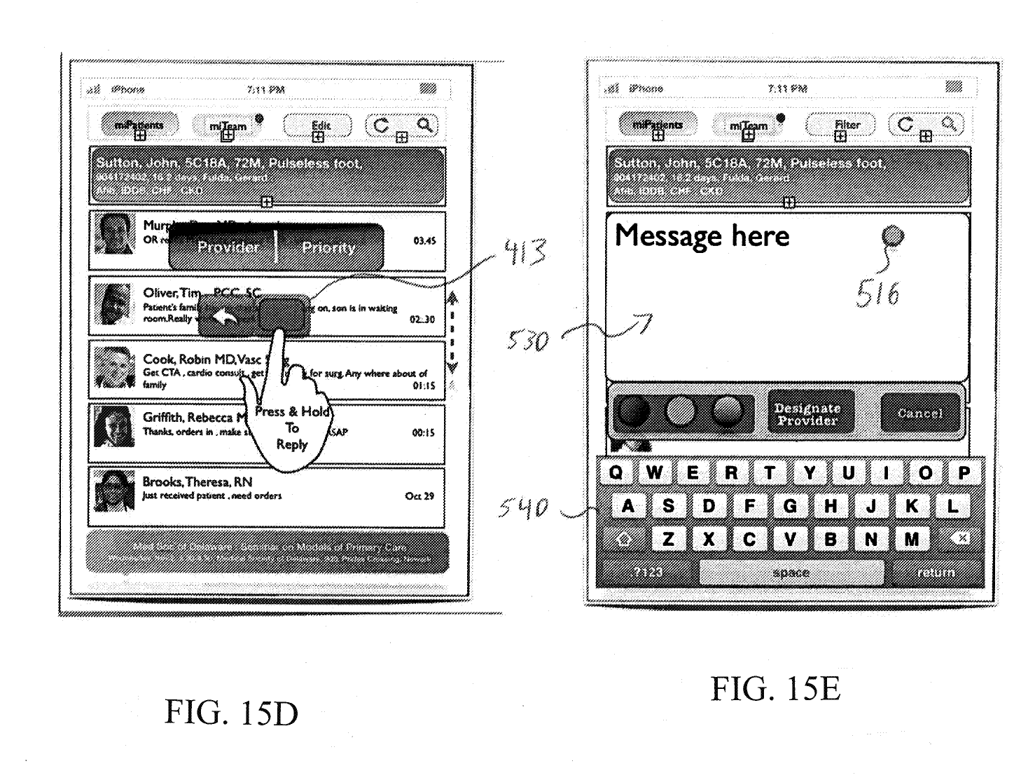

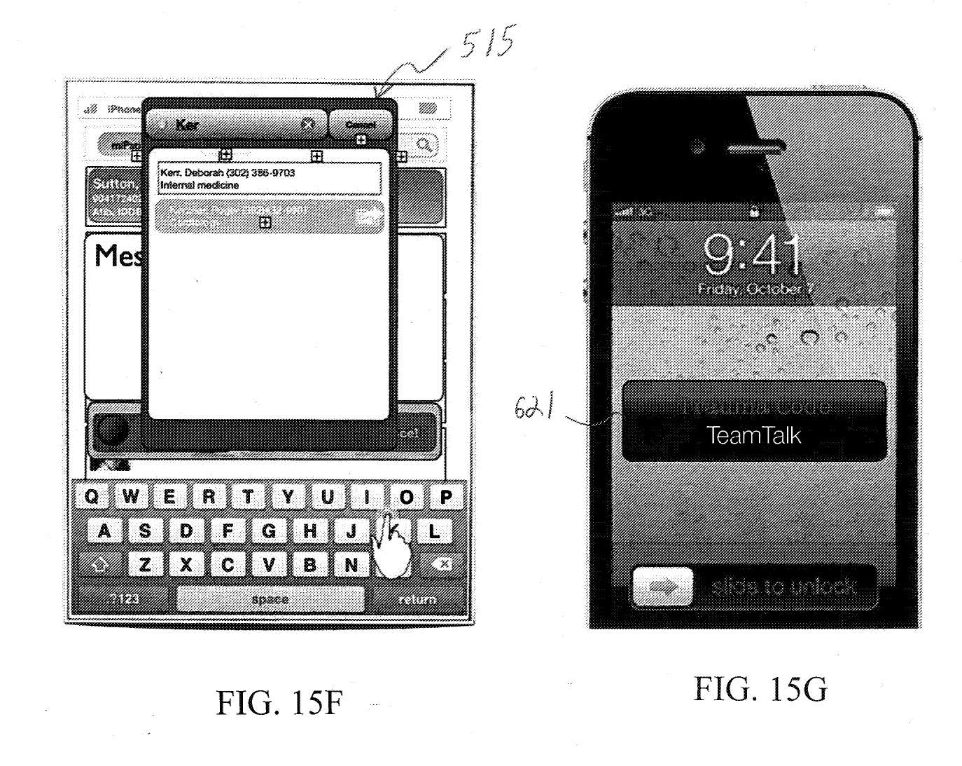

FIG. 15A-15F are screenshots illustrating various messaging capabilities of the present disclosure. As shown in FIG. 15A, a reply all button 411 and a specific reply button 413 are displayed by hovering over, or pressing and holding, a message 424a-424e under any display screen. As shown in FIGS. 15B-15C, when the reply all button 411 is selected, an interactive message area 430 and virtual keyboard 440 are displayed comprising a send button and cancel button. The reply all button 411 is preferably used for routine matters and non-urgent messages. As shown in FIGS. 15D-15E, when the specific reply button 413 is selected, an interactive message area 530 and virtual keyboard 540 are displayed comprising a “designate provider” button to send the message to a specific provider and a priority button (i.e., status identifier button) to designate priority of the message. The status identifier 516 chosen preferably shows up before the message is sent. To designate one or more specific providers, a separate window 515 pops up for searching, adding, and deleting recipients of a particular message, as shown in FIG. 15F.

Referring to FIG. 15G, when a message is sent, a notification 617 is displayed on a user's mobile phone. The notification 617 indicates whether a message is urgent or routine, but is otherwise generic without displaying any patient specifics. A notification 617 for a message sent to a specific provider will display as urgent for that specific provider, but will display as routine for the rest of the team. A notification 621 could also be sent for alerts to rapid response teams indicating the trauma code (e.g., code blue).

1. A system for patient-related messaging comprising:
an optional web server which generates a web portal accessible by telephones or computer systems, through which portal medical personnel can post or view messages in real time;
a messaging server; and
a database for storing messages.

2. The system of claim 1 further comprising a plurality of mobile devices or computing systems operated by healthcare professionals in network communication with the messaging system.

3. The system of claim 1 further comprising a patient data system containing healthcare information relating to a patient.

4. The system of claim 3 wherein the patient data system comprises a server and an associated patient records database which stores patient information.

5. The system of claim 4 wherein the patient data system is located at a medical facility.

6. The system of any claim 1 wherein the optional web server is absent and is replaced by local software application stored in telephones or computer systems accessing the messaging server.

7. The system of claim 6 wherein the local software application generates a local user interface display screen allowing users to post or view messages.

8. The system of claim 6 wherein the interface display screen is interactive.

9. The system of claim 7 wherein the display screen relates to patient-centric or team-centric message threads.

10. The system of claim 1 wherein the web portal comprises a message (blog) thread screen area which displays a plurality of message threads.

11. The system of claim 10 wherein the message (blog) thread screen area comprises a status identifier indicating whether a message thread includes an unviewed message or an urgent message.

12. The system of claim 1 wherein the web portal comprises a conversational screen area indicating the message thread selected and specific messages relating to one of the threads.

13. The system of claim 12 wherein the message thread is patient-centric, and comprises a patient list displaying a plurality of patients and information about the patient and the status of the patient.

14. The system of claim 13 wherein the information about the patient comprises one or more of the patient's name, date of birth, hospital ID, diagnosis, and location.

15. The system of claim 13 wherein the status of the patient comprises the condition of the patient or current symptoms.

16. The system of claim 1 wherein the web portal comprises a new thread creation wizard.

17. A method of selecting and editing message threads comprising:
a) logging into a system for patient-related messaging and optionally being authenticated thereby, whereby the system displays message threads;
b) selecting a desired message thread, which sends a query to a messaging database within the system to retrieve the messages associated with the selected message thread, wherein the messages from this query are displayed to the user;
c) determining whether the user desires to post a new message to the selected message thread;
i) wherein if the user decides to post a new message, the system displays a message composition screen, and the system allows the user to create a new message; once the message is drafted, the system posts the message and adds it to the message thread;
ii) after the new message is added to the message thread, or if the user determines not to post a new message, the user selects whether to go back to the message threads b) or end the session.

18. A method of creating a new thread in a system for patient-related messaging comprising:
a) determining whether the new thread is patient-related;
i) if yes, then
i-1) selecting a patient for the message thread;
i-2) selecting medical professionals or groups to receive the thread;
i-3) creating a thread title;
i-4) posting the thread; and
i-5) determining whether to create a new thread;
i-5a) if yes, then returning to a);
i-5b) if no, then ending method;
ii) if no, then
ii-1) determining whether the new thread is team-centric;
ii-1a) if no, then
ii-1a-1) selecting medical professionals or groups to receive the thread;
ii-1a-2) creating a thread title;
ii-1a-3) posting the thread; and
ii-1a-4) determining whether to create a new thread;
ii-1a-4a) if yes, then returning to a);
ii-1a-4b) if no, then ending method;
ii-1b) if yes, then
ii-1b-1) selecting a team for the message thread;
ii-1b-2) selecting medical professionals or groups to receive the thread;
ii-1b-3) creating a thread title;
ii-1b-4) posting the thread; and
ii-1b-5) determining whether to create a new thread;
ii-1b-5a) if yes, then returning to a);
ii-1b-5b) if no, then ending method.

19. The method of claim 17 wherein when a new or edited message is posted, a notification is displayed on a user's mobile phone.

20. The method of claim 19 wherein the notification indicates whether a message is urgent or routine.
